(19) United States
(12) Patent Application Publication
(10) Pub. No.: US 2015/0306979 A1
(43) Pub. Date: Oct. 29, 2015

(54) SLIDE RAIL

(71) Applicants: TOYOTA BOSHOKU KABUSHIKI KAISHA, Aichi-ken (JP); AISIN SEIKI KABUSHIKI KAISHA, Aichi-ken (JP); SHIROKI CORPORATION, Kanagawa (JP)

(72) Inventor: Naoki HAYASHI, Toyokawa-shi, Aichi-ken (JP)

(73) Assignees: TOYOTA BOSHOKU KABUSHIKI KAISHA, Aichi-ken (JP); AISIN SEIKI KABUSHIKI KAISHA, Aichi-ken (JP); SHIROKI CORPORATION, Kanagawa (JP)

(21) Appl. No.: 14/694,247

(22) Filed: Apr. 23, 2015

(30) Foreign Application Priority Data
Apr. 25, 2014 (JP) 2014-091066

(51) Int. Cl. B60N 2/07; B60N 2/075

(52) U.S. Cl. CPC B60N 2/0722; B60N 2/0705; B60N 2/075

(57) ABSTRACT

A slide rail includes a lower rail fitted to a vehicle structure member with use of a fixing member; and an upper rail. In a cross-section of the lower rail, the lower rail includes a lower face portion, paired side face portions extending upward from respective ends of the lower face in a width direction thereof, paired upper face portions respectively extending inward from upper ends of the side face portions, and paired flange portions respectively extending from inner end portions of the upper face portions, in parallel with the side face portions to face the side face portions. A discharge structure is provided in the flange portions to allow a foreign substance in the lower rail to be moved beyond the fixing member and to be discharged when a force is applied such that the foreign substance is moved toward an end portion of the lower rail.

### INCORPORATION BY REFERENCE

The disclosure of Japanese Patent Application No. 2014-091066 filed on Apr. 25, 2014 including the specification, drawings and abstract is incorporated herein by reference in its entirety.

### BACKGROUND OF THE INVENTION

1. Field of the Invention

The invention relates to a slide rail.

2. Description of Related Art

For example, Japanese Patent Application Publication No. 2005-8065 (JP2005-8065A) describes a slide rail including a lower rail that is fitted to a vehicle structure member such as a floor of a vehicle with the use of a fixing member; and an upper rail that is disposed on the side of a seat body and supported to be slidable with respect to the lower rail. JP2005-8065A describes a technology in which a plate spring is provided at or near a rear end portion of the lower rail. The plate spring is supported such that a rear end portion of the plate spring is pivotable in an up-down direction, and the plate spring applies an urging force in an upward direction. Thus, when a foreign substance enters the inside of the slide rail, the foreign substance is brought onto the plate spring by moving the upper rail rearward. A rear end portion of the foreign substance is brought upward by the plate spring, and thus, the foreign substance is discharge from the rear portion of the lower rail. In the technology described in JP2005-8065A, the lower rail is fitted to the vehicle structure member with the use of the fixing member such that a leg bracket is disposed between the lower rail and the fixing member, the leg bracket extending to a position behind and away from the rear end portion of the lower rail.

In the slide rail in JP2005-8065A, the plate spring is provided at or near the rear end portion of the lower rail, in order to give priority to the structure for discharging the foreign substance. Thus, the fixing member is provided at the position behind and away from the rear end portion of the lower rail. However, it is desired to provide the fixing member in a region of the lower rail, in order to reduce the entire length of the slide rail.

### SUMMARY OF THE INVENTION

The invention provides a slide rail whose entire length is reduced, and which is provided with a discharge structure that allows a foreign substance to be discharged.

An aspect of the invention relates to a slide rail including a lower rail that is fitted to a vehicle structure member with use of a fixing member; and an upper rail that is disposed on a side of a seat body, and supported to be slidable with respect to the lower rail. In a cross-section of the lower rail taken along a direction orthogonal to a longitudinal direction of the lower rail, the lower rail includes a lower face portion that is fastened to the vehicle structure member with the use of the fixing member, paired side face portions that extend upward from respective ends of the lower face portion in a width direction of the lower face portion, paired upper face portions that respectively extend inward from upper ends of the side face portions such that the upper face portions extend in parallel with the lower face portion to face the lower face portion, and paired flange portions that respectively extend from inner end portions of the upper face portions such that the flange portions respectively extend in parallel with the side face portions to face the side face portions; and a discharge structure is provided in the flange portions, and the discharge structure allows a foreign substance, which enters an inside of the lower rail, to be moved beyond the fixing member and to be discharged when a force is applied such that the foreign substance is moved toward an end portion of the lower rail.

According to the above-mentioned aspect, the lower face portion of the lower rail is fastened to the vehicle structure member with the use of the fixing member. Therefore, the fixing member is provided in a region of the lower rail. Thus, the lower rail can be made compact. In the cross-section of the lower rail taken along the direction orthogonal to the longitudinal direction of the lower rail, the lower rail includes the lower face portion, the paired side face portions, the paired upper face portions, the paired flange portions. Only a portion between the paired flange portions is open. Therefore, when a foreign substance enters through the opening portion, and enters an area between the flange portions and the lower face portion, it is difficult to take out the foreign substance. However, the discharge structure is provided in the flange portions, and the discharge structure allows the foreign substance, which enters the inside of the lower rail, to be moved beyond the fixing member and to be discharged when the force is applied such that the foreign substance is moved toward the end portion of the lower rail. Thus, it is possible to provide the slide rail whose entire length is reduced, and which is provided with the discharge structure that allows the foreign substance to be discharged.

In the above-mentioned aspect, the discharge structure may include cut portions each of which is provided by cutting at least a portion of a corresponding one of the flange portions, the portion facing the fixing member.

In the configuration, the discharge structure includes the cut portions each of which is provided by cutting at least a portion of a corresponding one of the flange portions, the portion facing the fixing member. Therefore, it is possible to provide the discharge structure that allows the foreign substance to be discharged, without increasing the number of components.

In the above-mentioned aspect, each of the cut portions may be provided to extend over at least an area from the portion facing the fixing member to an end portion of the lower rail in the longitudinal direction of the lower rail.

In the configuration, each of the cut portions is provided to extend over at least an area from the portion facing the fixing member to an end portion of the lower rail in the longitudinal direction of the lower rail. Therefore, it is possible to prevent the foreign substance from remaining in the lower rail.

In the above-mentioned aspect, a center-side end portion of each of the cut portions may have a tapered shape, the center-side end portion of the cut portion being closer to a center of the lower rail in the longitudinal direction of the lower rail than another end portion of the cut portion is.

In the configuration, the center-side end portion of each of the cut portions has a tapered shape, the center-side end portion of the cut portion being closer to a center of the lower rail in the longitudinal direction of the lower rail than another end portion of the cut portion is. Therefore, the discharge structure allows the foreign substance to be smoothly discharged.

In the above-mentioned aspect, the vehicle structure member may be a floor surface of a vehicle.

According to the above-mentioned aspect of the invention, it is possible to provide the slide rail whose entire length is reduced, and which is provided with the discharge structure that allows the foreign substance to be discharged.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing an entire vehicle seat according to an embodiment of the invention;

FIG. 2 is an exploded perspective view showing a slide rail device in the vehicle seat according to the embodiment;

FIG. 3 is a sectional view in a longitudinal direction showing a front end portion of the slide rail device in the vehicle seat according to the embodiment;

FIG. 4 is a sectional view in the longitudinal direction showing a rear end portion of the slide rail device in the vehicle seat according to the embodiment;

FIG. 5 is a sectional view taken along a line V-V in FIG. 3;

FIG. 6 is a perspective showing a state in which a foreign substance enters an inside of the slide rail device in the vehicle seat;

FIG. 7 is a perspective view showing a state in which the foreign substance rides on the floor bolt in the slide rail device;

FIG. 8 is a perspective view showing a state in which the foreign substance moves beyond the floor bolt in the slide rail device; and

FIG. 9 is a perspective view showing a state in which the foreign substance is discharged from the slide rail device.

### DETAILED DESCRIPTION OF EMBODIMENTS

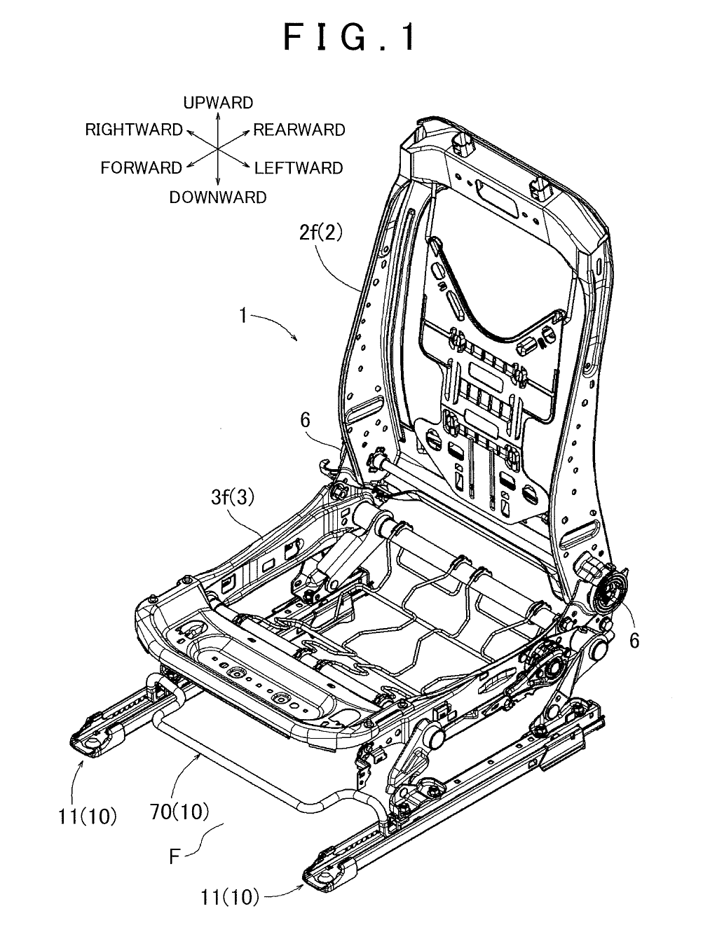

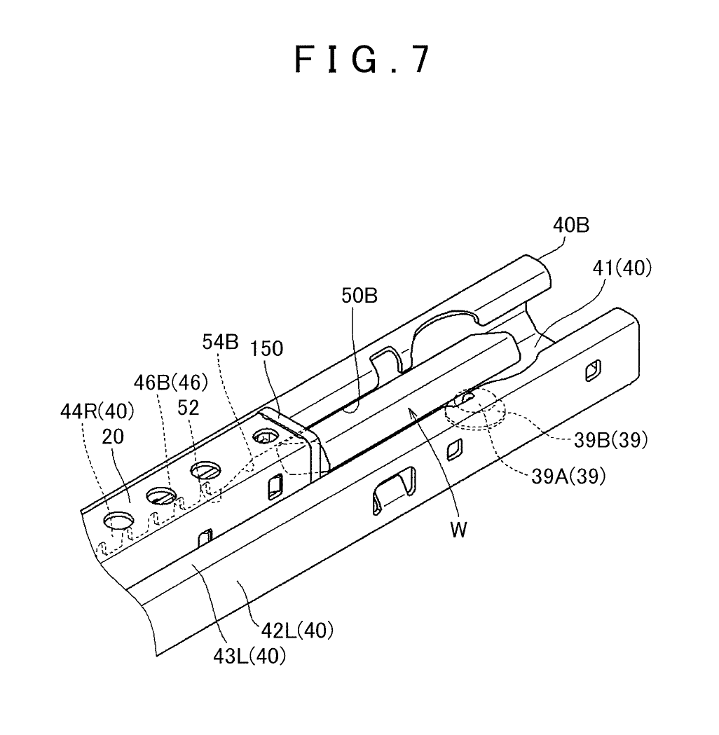

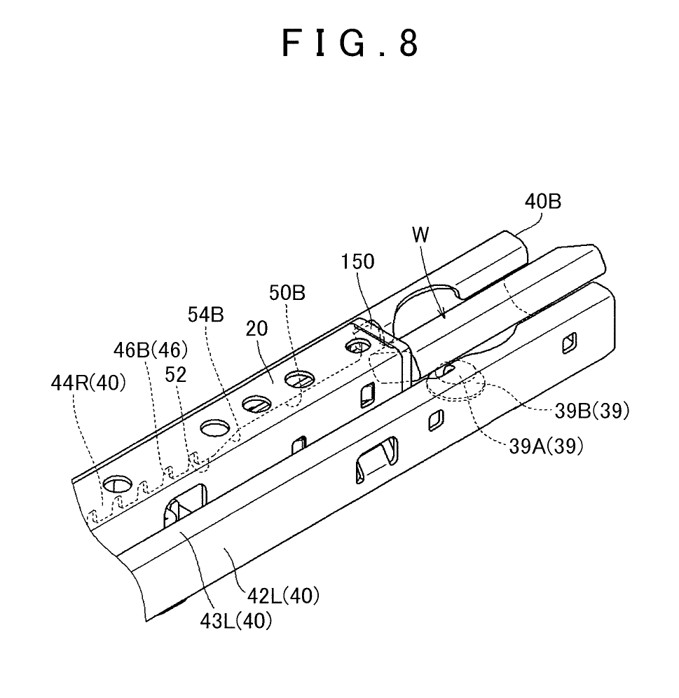

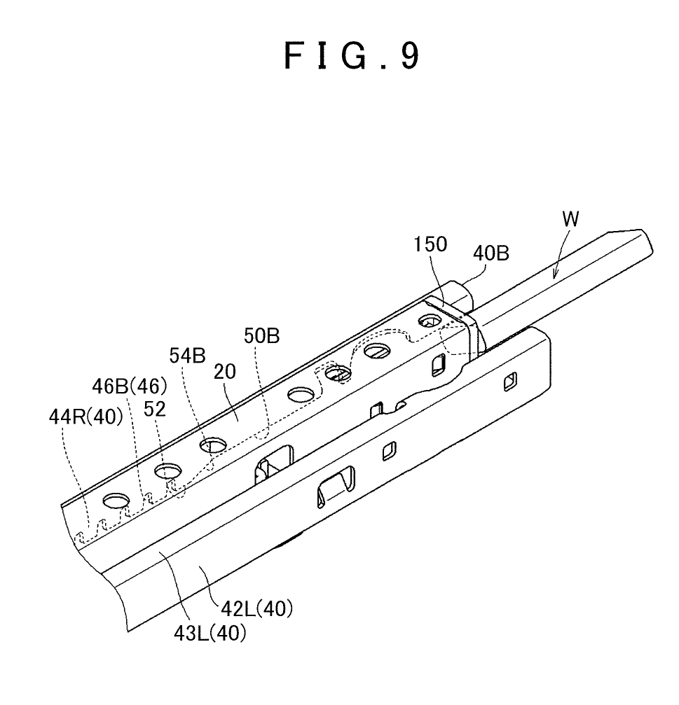

A slide rail according to an embodiment of the invention will be described with reference to FIG. 1 to FIG. 9. In the embodiment, a vehicle front seat will be described as an example of the vehicle seat. In each drawing, directions, which are appropriately indicated by arrows, respectively coincide with forward, rearward, upward, downward, rightward, and leftward directions when seen from an occupant seated on the vehicle seat that is employed for a vehicle and is disposed to face toward a front side of the vehicle. Each drawing mainly shows the inner structure of a seat body in order to facilitate understanding of the configuration in the embodiment. Therefore, with regard to a seat back 2 and a seat cushion 3, each drawing mainly shows the inner frame structure thereof, such as a back frame 2f and a cushion frame 3f that form a frame. Thus, descriptions and illustrations of members fitted to the outside, for example, a cover and a seat pad, may be omitted.

As shown in FIG. 1, a vehicle seat includes a seat body 1 that mainly includes the seat back 2 that is a back portion, and the seat cushion 3 that is a seating portion. The seat back 2 includes the back frame 2f that is a frame portion. The back frame 2f is formed to have a substantially rectangular frame shape, by appropriately performing a bending process, a drawing process, and the like on a pipe member and a plate member that are made of a steel material. The seat cushion 3 includes the cushion frame 3f that is a frame portion. The cushion frame 3f is formed to have a substantially rectangular frame shape, by appropriately performing a bending process, a drawing process, and the like on a pipe member and a plate member that are made of a steel material. In the seat body 1, the back frame 2f is connected to the cushion frame 3f by reclining devices 6, 6 that are provided in a lower portion of the back frame 2f in an up-down direction. Thus, the reclining angle of the seat back 2 with respect to the seat cushion 3 can be adjusted, and the seat back 2 is tiltable forward with respect to the seat cushion 3.

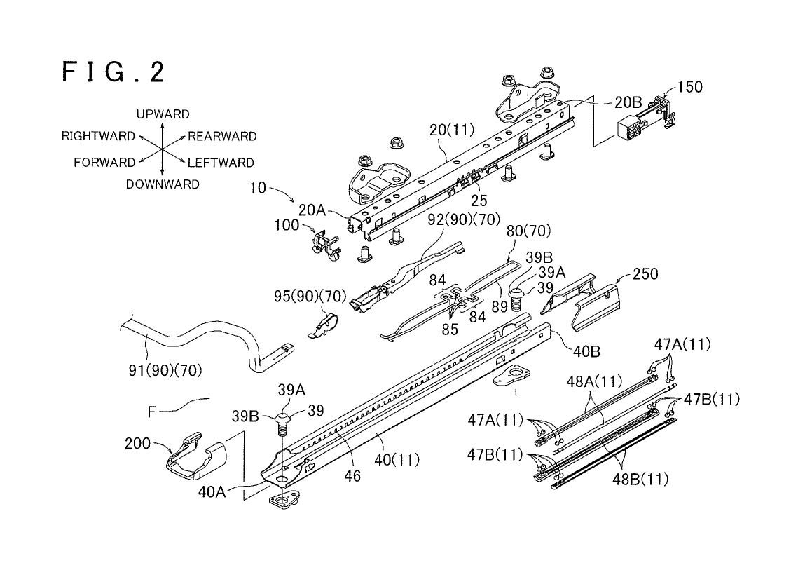

As shown in FIG. 1 and FIG. 2, the vehicle seat includes the slide rail device 10 provided between the seat body 1 and a floor surface F of the vehicle (i.e., a vehicle structure member). The slide rail device 10 makes it possible to adjust the seating position of the seat body 1 with respect to the floor surface F in a vehicle front-rear direction. As shown in FIG. 1, the slide rail device 10 includes slide rails 11, 11, and a slide lock mechanism 70. The paired right and left slide rails 11, 11 are disposed between the seat cushion 3 and the floor surface F such that the slide rails 11, 11 extend in the vehicle front-rear direction and in parallel with each other.

As shown in FIG. 1, the slide rails 11, 11 are disposed between the seat body 1 and the floor surface F of the vehicle. The slide rails 11, 11 form a mechanism that moves the seating position of the seat body 1 with respect to the floor surface F in the vehicle front-rear direction. As shown in FIG. 2, each of the slide rails 11, 11 mainly includes a lower rail 40, an upper rail 20, rolling elements 47A, 47B, and guides 48A, 48B. The lower rails 40 extend in the vehicle front-rear direction, and are disposed on the floor surface F. The upper rails 20 are disposed on the side of the seat body 1 (refer to FIG. 1), and are respectively fitted to the lower rails 40 such that the upper rails 20 are slidable with respect to the lower rails 40 in the longitudinal direction of the upper rails 20 and the lower rails 40. More specifically, each of the lower rails 40 and a corresponding one of the upper rails 20 are overlapped with each other via the rolling elements 47A, 47B and the guides 48A, 48B so as to form a tubular shape. Thus, when the upper rails 20 are guided to slide with respect to the lower rails 40 in the vehicle front-rear direction, the seating position of the seat body 1 is moved in the vehicle front-rear direction.

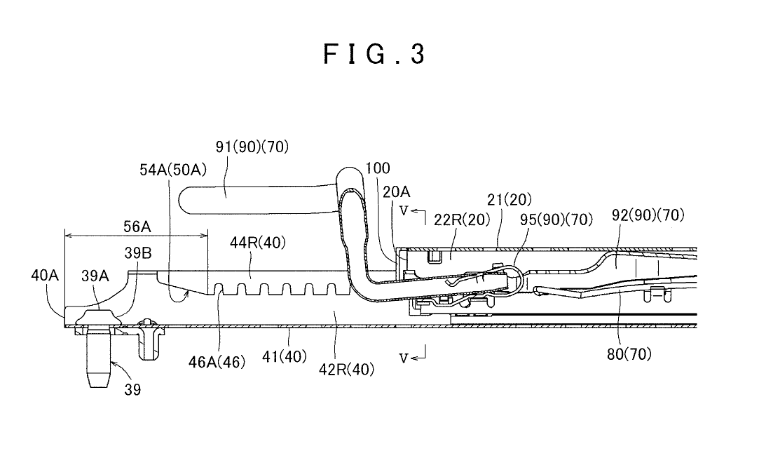

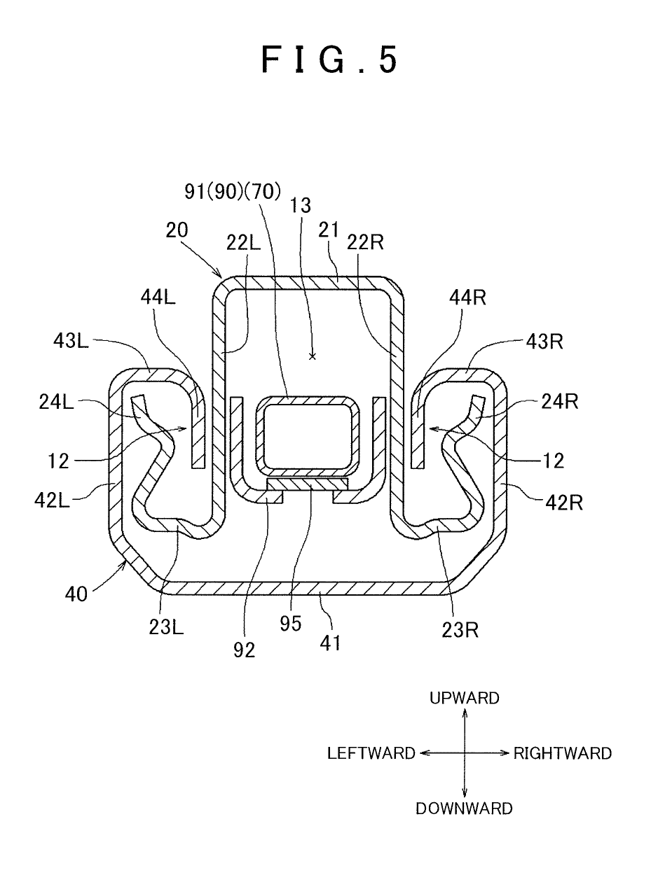

As shown in FIG. 2, each of the lower rails 40 extends in the vehicle front-rear direction, and is disposed on the floor surface F. As shown in FIG. 5, the lower rail 40 is formed as one body having a cross-section described below, by bending portions of one flat plate member made of steel. More specifically, in the cross-section of the lower rail 40 taken along a direction orthogonal to the longitudinal direction of the lower rail 40, the lower rail 40 includes a lower face portion 41 that is in the form of a flat plate, and that is disposed on the floor surface F (refer to FIG. 2) to extend in substantially parallel with the floor surface F. The lower face portion 41 is fastened to the floor surface F with the use of floor bolts 39 (that correspond to “a fixing member” according to the invention) (refer to FIG. 2) at a position in the vicinity of a front end portion 40A and a position in the vicinity of a rear end portion 40B. A right side face portion 42R and a left side face portion 42L extend upward in a vertical direction from respective ends of the lower face portion 41 in a width direction of the lower face portion 41. Each of the right side face portion 42R and the left side face portion 42L is in the form of a flat plat. A right upper face portion 43R and a left upper face portion 43L respectively extend inward from upper ends of the right side face portion 42R and the left side face portion 42L such that the right upper face portion 43R and the left upper face portion 43L extend in parallel with the lower face portion 41 to face the lower face portion 41. Each of the right upper face portion 43R and the left upper face portion 43L is in the form of a flat plate. A right flange portion 44R and a left flange portion 44L respectively extend (downward in the vertical direction) from inner end portions of the right upper face portion 43R and the left upper face portion 43L such that the right flange portion 44R and the left flange portion 44L respectively extend in parallel with the right side face portion 42R and the left side face portion 42L to face the right side face portion 42R and the left side face portion 42L. Each of the right flange portion 44R and the left flange portion 44L is in the form of a flat plate. As shown in FIG. 2 and FIG. 3, in the right flange portion 44R and the left flange portion 44L, a plurality of lock grooves 46 are disposed adjacent to each other in a slide direction. Each of the lock grooves 46 extends in the up-down direction. An end portion of each of the lock grooves 46 is open. The right side face portion 42R and the left side face portion 42L correspond to “paired side face portions” according to the invention. The right upper face portion 43R and the left upper face portion 43L correspond to “paired upper face portions” according to the invention. The right flange portion 44R and the left flange portion 44L correspond to “paired flange portions” according to the invention.

As shown in FIG. 2, each of the upper rails 20 is disposed on the side of the seat body 1 (refer to FIG. 1), and is fitted to the corresponding lower rail 40 such that the upper rail 20 is slidable with respect to the corresponding lower rail 40 in the rail longitudinal direction. As shown in FIG. 5, the upper rail 20 is formed as one body having a cross-section described below, by bending portions of one flat plate member made of steel. More specifically, in the cross-section of the upper rail 20 taken along the direction orthogonal to the longitudinal direction of the upper rail 20, the upper rail 20 includes an upper face portion 21 that is in the form of a flat plate. The upper face portion 21 faces the floor surface F and extends in substantially parallel with the floor surface F. A right side face portion 22R and a left side face portion 22L extend straight and downward from respective ends of the upper face portion 21. Each of the right side face portion 22R and the left side face portion 22L is in the form of a flat plate. A right folded face portion 23R and a left folded face portion 23L respectively extend outward from lower ends of the right side face portion 22R and the left side face portion 22L. Each of the right folded face portion 23R and the left folded face portion 23L is a curved surface. A right distal end portion 24R and a left distal end portion 24L respectively extend upward from outer end portions of the right folded face portion 23R and the left folded face portion 23L. Each of the right distal end portion 24R and the left distal end portion 24L has a bent shape. As shown in FIG. 2, in the right distal end portion 24R and the left distal end portion 24L of the upper rail 20, cut grooves 25 are provided for the lock grooves 46 arranged in the slide direction in the lower rail 40. Each of the cut grooves 25 is formed by partially cutting the right distal end portion 24R and the left distal end portion 24L.

As shown in FIG. 5, with regard to the lower rail 40 and the upper rail 20, in the cross-section taken along the direction orthogonal to the longitudinal direction thereof, the upper rail 20 is inserted into and disposed inside the lower rail 40, and the right flange portion 44R and the left flange portion 44L of the lower rail 40 are overlapped with the right distal end portion 24R and the left distal end portion 24L of the upper rail 20 in the direction orthogonal to the longitudinal direction. Thus, fitting portions 12 that prevent the lower rail 40 and the upper rail 20 from separating from each other are formed.

As shown in FIG. 2, the slide lock mechanism 70 is a mechanism that restrains the slide movement of the slide rails 11 at an appropriate position (a selected position) in the vehicle front-rear direction. The slide lock mechanism 70 mainly includes a lock spring 80 and an operating member 90.

As shown in FIG. 2, the lock spring 80 functions as a lock member that restrains the slide movement of the upper rail 20 with respect to the lower rail 40 at an appropriate position (a selected position) to achieve a slide lock state by being engaged with the lock grooves 46 and the cut grooves 25, and the lock spring 80 also has a function of performing elastic urging, i.e., elastically applies an urging force to maintain the slide lock state. The lock spring 80 is constituted by a linear member 89 that is made of metal and has a uniform cross-section.

As shown in FIG. 2, the operating member 90 is a member that transmits, to the lock spring 80, a canceling operating force (in other words, an unlocking operating force) of an operator, in order to cancel the slide lock state in which the lock spring 80 provided as the lock member is engaged with the lock grooves 46 and the cut grooves 25. The operating member 90 mainly includes a loop handle 91, a lever member 92, and a plate spring 95. The loop handle 91 is a member that receives the canceling operating force for cancelling the slide lock state of the lock spring 80 in the slide lock mechanism 70. The lever member 92 is a member that outputs and transmits the canceling operating force of the loop handle 91 to the lock spring 80. The lever member 92 presses elastic deformation portions 84 of the lock spring 80 disposed inside the slide rail 11 to elastically deform the elastic deformation portions 84 in the up-down direction such that the engagement grooves 85 are able to be engaged with and disengaged from the lock grooves 46 and the cut grooves 25. The lever member 92 is formed as an elongated member, by performing a bending process on a plate member made of metal. As shown in FIG. 3 and FIG. 5, the lever member 92 is disposed in a space portion 13 (refer to FIG. 5) that is located between the upper face portion 21 of the upper rail 20 and the lower face portion 41 of the lower rail 40, and that is located between the right side face portion 22R and the left side face portion 22L of the upper rail 20. The plate spring 95 connects the loop handle 91 and the lever member 92 such that the loop handle 91 is rotatable in the vehicle up-down direction relative to the lever member 92 (in other words, the loop handle 91 is movable in the vehicle up-down direction relative to the lever member 92). The plate spring 95 urges the loop handle 91 toward the initial position at which the loop handle 91 is located before the operation of the loop handle 91 is started.

As shown in FIG. 2, caps 100 and 150, and caps 200 and 250 are respectively provided in the upper rail 20 and the lower rail 40 of the slide rail 11 to protect end portions thereof. The caps 100, 150, 200, 250 are made of synthetic resin, and are fitted in the rail end portions. The cap 100 is provided in a front end portion 20A of the upper rail 20. The cap 150 is provided in a rear end portion 20B of the upper rail 20. The cap 200 is provided in the front end portion 40A of the lower rail 40. The cap 250 is provided in the rear end portion 40B of the lower rail 40.

A discharge structure is provided in the right flange portion 44R and the left flange portion 44L of the slide rail 11. The discharge structure allows a foreign substance W, which enters the inside of the lower rail 40, to be moved beyond the floor bolt 39 (the fixing member) and to be discharged when a force is applied such that the foreign substance W is moved toward the end portion of the lower rail 40. The discharge structure includes cut portions each of which is formed (provided) by cutting at least a portion of a corresponding one of the right flange portion 44R and the left flange portion 44L of the lower rail 40, the portion facing the floor bolt 39. The cut portions include front cut portions 50A provided in and in the vicinity of the front end portion 40A of the lower rail 40, and rear cut portions 50B provided in and in the vicinity of the rear end portion 40B of the lower rail 40.

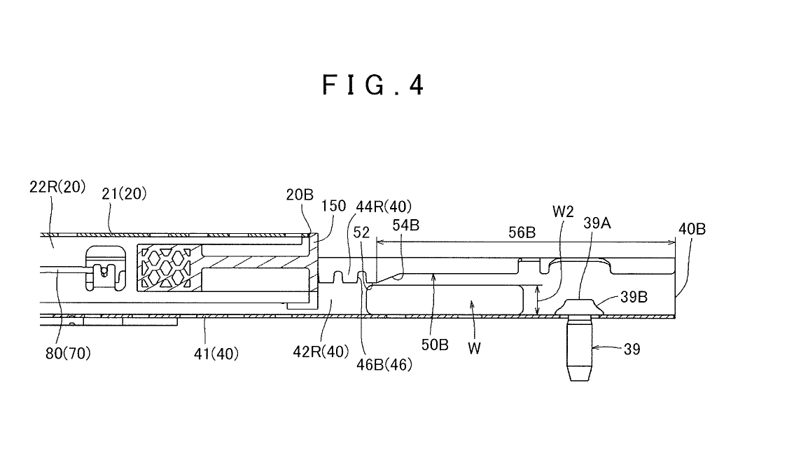

As shown in FIG. 4, each of the rear cut portions 50B is provided by cutting at least a portion, in a length direction, of a corresponding one of the right flange portion 44R and the left flange portion 44L (refer to FIG. 5). More specifically, each of the rear cut portions 50B is provided by cutting at least a portion of a corresponding one of the right flange portion 44R and the left flange portion 44L, the portion facing the floor bolt 39. Each of the rear cut portions 50B is provided adjacent to a lock groove 46B at the rearmost position in the longitudinal direction. More specifically, each of the rear cut portions 50B is provided to extend from a center-side portion of the lower rail 40 to the rear end portion 40B of the lower rail 40, the center-side portion being closer to a center of the lower rail 40 in the longitudinal direction than the floor bolt 39 is (each of the rear cut portions 50B is provided to extend over an area including the floor bolt 39, in other words, each of the rear cut portions 50B is provided to extend over at least an area from the portion facing the floor bolt 39 to the rear end portion 40B of the lower rail 40). A center-side end portion of each of the rear cut portions 50B is a portion at which a lower end 52 of a corresponding one of the right flange portion 44R and the left flange portion 44L is connected to (continuous with) the rear cut portion 50B, the center-side end portion of the rear cut portion 50B being closer to the center of the lower rail 40 in the longitudinal direction than a rear end portion (another end portion) of the rear cut portion 50B is. The rear cut portion 50B includes a rear tapered portion 54B that has a tapered shape. More specifically, the rear tapered portion 54B is tapered (gradually inclined) from the lower end 52 toward the rear end portion of the rear cut portion 50B. A rear cut length 56B of the rear cut portion 50B (i.e., a length of the rear cut portion 50B) is set to be a length that allows the foreign substance W to be moved beyond the floor bolt 39 and to be passed through the lower rail 40. Since the right flange portion 44R and the left flange portion 44L also function as the fitting portions 12 that prevent the separation of the lower rail 40 and the upper rail 20, each of the cut portions may be provided by cutting a portion, in the length direction, of a corresponding one of the right flange portion 44R and the left flange portion 44L, and a portion of each of the right flange portion 44R and the left flange portion 44L may be maintained. A head portion 39A of the floor bolt 39 has an inclined face 39B that is tapered toward a distal end thereof such that the foreign substance W is not caught by the floor bolt 39 (the movement of the foreign substance W is not interfered with (blocked) by the floor bolt 39).

As shown in FIG. 3, the front cut portions 50A are provided adjacent to a lock groove 46A at the front position in the longitudinal direction. The right flange portion 44R and the left flange portion 44L (refer to FIG. 5) are not provided in a portion of the front end portion 40A of the lower rail 40. In other words, in a portion of the front end portion 40A of the lower rail 40, the entire right flange portion 44R and the entire left flange portion 44L are cut off. The right flange portion 44R and the left flange portion 44L are provided to extend from a position that is offset from the front end portion 40A toward the center of the lower rail 40 in the longitudinal direction by a predetermined length. Therefore, each of the front cut portions 50A is constituted by only a front tapered portion 54A (in other words, in each of the front cut portions 50A, only the front tapered portion 54A is disposed). A front cut length 56A of each of the front cut portions 50A (i.e., a length of each of the front cut portions 50A) is set in the same manner as the manner in which the rear cut length 56B of each of the rear cut portions 50B is set.

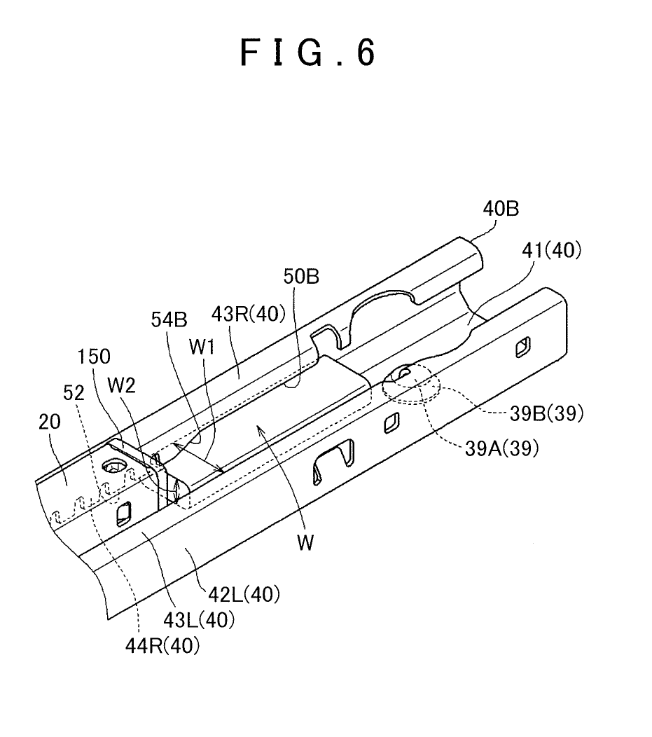

The discharge structure will be described with a focus on the rear cut portion 50B provided in and in the vicinity of the rear end portion 40B of the lower rail 40. The front cut portion 50A provided in and in the vicinity of the front end portion 40A is substantially the same as or similar to the rear cut portion 50B. As shown in FIG. 6 to FIG. 9, it is assumed that the shape of the foreign substance W is a rectangular parallelepiped, the foreign substance W has a width W I such that the foreign substance W is able to pass through an area between the right flange portion 44R and the left flange portion 44L (refer to FIG. 5), and the foreign substance W has a thickness W2 such that the foreign substance W enters an area between the lower ends 52 and the lower face portion 41. When the foreign substance W falls into the lower rail 40 and enters the area between the lower ends 52 and the lower face portion 41, it is difficult to take out the foreign substance W from an opening portion between the right flange portion 44R and the left flange portion 44L. When the upper rail 20 is slid rearward, the cap 150 fitted to the rear end portion 20B (refer to FIG. 2 and FIG. 4) pushes the foreign substance W, and thus, the foreign substance W is moved toward the rear end portion 40B. The foreign substance W is moved upward by the inclined face 39B of the floor bolt 39, and is inclined (tilted) toward any one of both sides in the width direction of the lower rail 40. At this time, although the foreign substance W is in an inclined posture, the foreign substance W is movable in the slide direction, in an area where the rear cut portions 50B are provided (due to the rear cut portions 50B). The foreign substance W is further moved toward the rear end portion 40B due to the movement of the upper rail 20, and the foreign substance W is moved beyond the floor bolt 39 and is discharged through the rear end portion 40B of the lower rail 40.

Thus, in the slide rail 11 according to the embodiment, the lower face portion 41 of the lower rail 40 is fastened to the floor surface F (the vehicle structure member) with the use of the floor bolts 39 (the fixing member). Thus, each of the floor bolts 39 is provided in a region of the lower rail 40. Accordingly, the compact-sized lower rail 40 is provided (the lower rail 40 can be made compact). In the cross-section of the lower rail 40 taken along the direction orthogonal to the longitudinal direction of the lower rail 40, the lower rail 40 includes the lower face portion 41, the right side face portion 42R and the left side face portion 42L (the paired side face portions), the right upper face portion 43R and the left upper face portion 43L (the paired upper face portions), and the right flange portion 44R and the left flange portion 44L (the paired flange portions). In the lower rail 40, only a portion between the right flange portion 44R and the left flange portion 44L is open. Therefore, if the foreign substance W enters through the opening portion and enters the area between the lower ends 52 and the lower face portion 41, it is difficult to take out the foreign substance W. However, in the right flange portion 44R and the left flange portion 44L, there is provided the discharge structure that allows the foreign substance W, which enters the inside of the lower rail 40, to be moved beyond the floor bolt 39 and to be discharged when the force is applied such that the foreign substance W is moved toward the end portion of the lower rail 40. Thus, it is possible to provide the compact-sized slide rail 11 whose entire length is reduced, and which is provided with the discharge structure that allows the foreign substance W to be discharged.

The discharge structure includes the front cut portions 50A and the rear cut portions 50B, each of which is provided by cutting at least a portion of a corresponding one of the right flange portion 44R and the left flange portion 44L, the portion facing the floor bolt 39. Thus, it is possible to provide the discharge structure that allows the foreign substance W to be discharged, without increasing the number of components. Further, each of the front cut portions 50A is provided to extend over at least the area from the portion facing the floor bolt 39 to the front end portion 40A of the lower rail 40 in the longitudinal direction of the lower rail 40. Similarly, each of the rear cut portions 50B is provided to extend over at least the area from the portion facing the floor bolt 39 to the rear end portion 40B of the lower rail 40 in the longitudinal direction of the lower rail 40. Therefore, it is possible to prevent the foreign substance W from remaining inside the lower rail 40. Further, the front tapered portion 54A is provided in a center-side end portion of each of the front cut portions 50A, the center-side end portion of the front cut portion 50A being closer to the center of the lower rail 40 in the longitudinal direction than a front end portion (another end portion) of the front cut portion 50A is. Similarly, the rear tapered portion 54B is provided in the center-side end portion of each of the rear cut portions 50B, the center-side end portion of the rear cut portion 50B being closer to the center of the lower rail 40 in the longitudinal direction than the rear end portion (the other end portion) of the rear cut portion 50B is. Thus, the discharge structure allows the foreign substance W to be smoothly discharged.

Although the embodiment of the invention is described above, the slide rail according to the invention is not limited to the embodiment, and may be realized in other embodiments. In the above-mentioned embodiment, each of the cut portions in the discharge structure is provided by cutting a portion of the flange portion. However, the entire flange portion may be cut. The discharge structure is not limited to the cut portions.

Any discharge structure may be employed as long as the discharge structure allows the foreign substance, which enters the inside of the lower rail, to be moved beyond the fixing member and to be discharged when the force is applied such that the foreign substance is moved toward the end portion of the lower rail. Therefore, instead of the cut portion, a deformable portion that is deformable when the foreign substance is moved may be provided. For example, a rubber member or a synthetic resin, which is an elastic member, may be provided. A rubber member, a synthetic resin, or the like, which is an elastic member, may be fitted to a distal end defining the cut portion. Further the shape of the head portion of the floor bolt, which is the fixing member, is not limited to the shape in the embodiment. The head portion of the fixing member may have any shape as long as the foreign substance is able to be moved beyond the fixing member. Therefore, for example, the head portion of the fixing member may have an arc shape, or a shape of a flat head screw (a flush head screw) or the like that is flush with the lower face portion of the lower rail. In the above-mentioned embodiment, both of the lock member and the operating member are provided inside the slide rail. However, the invention is not limited to this configuration. For example, the lock member and/or the operating member may be provided outside the slide rail.

The term vehicle may refer to any machine or conveyance that carries people or thins from one place to another such as an automobile, a truck, a bus, a train, an aircraft, a boat, a vessel, and a submarine. However, it is noted that these examples are merely provided for purposes of enhancing understanding the present disclosure, and thus should not be construed as limiting.

What is claimed is:

1. A slide rail comprising:
a lower rail that is fitted to a vehicle structure member with use of a fixing member; and
an upper rail that is disposed on a side of a seat body, and supported to be slidable with respect to the lower rail, wherein:
in a cross-section of the lower rail taken along a direction orthogonal to a longitudinal direction of the lower rail, the lower rail includes a lower face portion that is fastened to the vehicle structure member with the use of the fixing member, paired side face portions that extend upward from respective ends of the lower face portion in a width direction of the lower face portion, paired upper face portions that respectively extend inward from upper ends of the side face portions such that the upper face portions extend in parallel with the lower face portion to face the lower face portion, and paired flange portions that respectively extend from inner end portions of the upper face portions such that the flange portions respectively extend in parallel with the side face portions to face the side face portions; and
a discharge structure is provided in the flange portions, and the discharge structure allows a foreign substance, which enters an inside of the lower rail, to be moved beyond the fixing member and to be discharged when a force is applied such that the foreign substance is moved toward an end portion of the lower rail.

2. The slide rail according to claim 1, wherein the discharge structure includes cut portions each of which is provided by cutting at least a portion of a corresponding one of the flange portions, the portion facing the fixing member.

3. The slide rail according to claim 2, wherein each of the cut portions is provided to extend over at least an area from the portion facing the fixing member to the end portion of the lower rail in the longitudinal direction of the lower rail.

4. The slide rail according to claim 2, wherein a center-side end portion of each of the cut portions has a tapered shape, the center-side end portion of the cut portion being closer to a center of the lower rail in the longitudinal direction of the lower rail than another end portion of the cut portion is.

5. The slide rail according to claim 1, wherein the vehicle structure member is a floor surface of a vehicle.
